(19) United States
(12) Patent Application Publication
(10) Pub. No.: US 2025/0321867 A1
(43) Pub. Date: Oct. 16, 2025

(54) System and Method for Test Case Optimizations for Software Testing

(71) Applicant: CBS Interactive Inc., San Francisco, CA (US)

(72) Inventors: Partha Sarathi SAMAL, Rocky Hill, CT (US); Suresh Kumar PALUS, Secane, PA (US); Behrang ZANDI, Danville, CA (US); Vikas SWAMI, Lakeland, FL (US); Alina CHERNYSHOVA, McLean, VA (US); Shaveta BALI, Normal, IL (US); Ivan MEDVEDIEV, Centreville, VA (US)

(21) Appl. No.: 18/631,762

(22) Filed: Apr. 10, 2024

(51) Int. Cl. G06F 11/36

(52) U.S. Cl. CPC G06F 11/3688

(57) ABSTRACT

An automation testing system includes a processor and a memory storing historical data which at least comprising past test results including input parameters and testing outcomes for each test case included in the past test results. The processor is configured to identify input parameters for a first iteration of a first software application having first functionalities; execute an initial test on the first iteration to generate initial results; based on the input parameters and the initial results, collecting first historical data at least comprising first past test results for at least one second software application having second functionalities corresponding to the first functionalities; training a model employing AI or ML based on the initial results and the first historical data to generate a trained model; executing the trained model with the input parameters as input to generate a set of test cases for testing the first functionalities.

### BACKGROUND

The software development process includes many stages of testing. A typical testing cycle generally includes the generation of test cases designed to validate aspects of the software including, e.g., functionality and performance. Different inputs are provided to the software and the output is validated against expected results. Test cases can be developed based on different considerations including software requirements, design specifications, past issues, etc. Generating test cases manually can be a complex and time-intensive process.

Some types of software testing can be automated. Automation testing refers to automated tools for software testing tasks. One type of automated software testing is exhaustive testing (or brute force testing), in which test cases of all possible combinations of input variables in a software application are generated and executed. However, exhaustive testing may not be feasible, particularly for complicated software, due to the time/processing required for testing all combinations of input variables. Another type of automated software testing is pairwise testing in which test cases comprising combinations of input parameters are generated to cover a large number of potential interactions between input parameters.

Existing pairwise testing processes can reduce the number of test cases relative to exhaustive testing. However, this may still impose a high processing/time burden and can potentially miss some software defects. Additionally, the software development process typically includes multiple iterations of testing. Existing automated testing processes do not include features for learning from past tests, e.g., to focus on input variables most likely to reveal defects. Thus, the inefficiencies of certain current automation testing processes are compounded over multiple stages of testing as time and/or computing resources are expended on redundant test cases or by failing to uncover defects in aspects of code that are not adequately tested.

### SUMMARY

The present disclosure relates to a computer-implemented method for training a machine learning (ML) model for generating test cases for software testing. The method includes collecting historical data from one or more digital repositories, the historical data comprising past test results for a first software application having one or more first functionalities and at least one second software application having one or more second functionalities corresponding to the one or more first functionalities of the first software application, the past test results at least including input parameters and testing outcomes for each test case included in the past test results; creating a first training dataset structured to associate the testing outcomes with the input parameters under which test cases were executed; and training the ML model with the first training dataset to generate a trained ML model.

In an embodiment, the ML model is a decision tree or a random forest.

In an embodiment, the method further includes executing the trained ML model with input data comprising first input parameters for the first software application; and generating output data comprising a classification of testing scenarios for prioritizing test cases for the first software application.

In an embodiment, the classification of testing scenarios is based on a likelihood of a given testing scenario to reveal defects.

In an embodiment, the method further includes when a next iteration of the first software application is received for testing, creating a second training dataset comprising code changes relative to a previous iteration of the first software application or bug reports for the previous iteration of the first software application; and re-training the trained ML model with the second training dataset to generate a re-trained ML model.

In an embodiment, the classification of testing scenarios is based on a relevance to code changes between the next iteration and the previous iteration of the first software application.

In an embodiment, the ML model is a neural network.

In an embodiment, the first training dataset further comprises code changes for a next iteration of the first software application relative to a previous iteration of the first software application included in the past test cases. The method further includes generating output data comprising a classification of testing scenarios based on a relevance to code changes between the next iteration and the previous iteration of the first software application.

In addition, the present disclosure relates to an automation testing system. The system includes a memory configured to store historical data collected from one or more digital repositories, the historical data at least comprising past test results including input parameters and testing outcomes for each test case included in the past test results. The system also includes a processor configured to: identify input parameters for a first iteration of a first software application having one or more first functionalities to be tested; execute an initial test on the first iteration of the first software application to generate initial test results; based on the input parameters and the initial test results, collecting first historical data at least comprising first past test results for at least one second software application having one or more second functionalities corresponding to the one or more first functionalities of the first software application; training a model employing artificial intelligence (AI) or machine learning (ML) based on the initial test results and the first historical data to generate a trained model; and executing the trained model with the input parameters as input to generate a set of test cases for testing the one or more first functionalities of the first software application.

In an embodiment, the initial test is a pairwise test run with orthogonal arrays, wherein the pairwise test provides a basis for collecting the first historical data.

In an embodiment, the model is trained based on statistical analysis of the first historical data, the statistical analysis comprising at least one of descriptive statistics for summarizing and describing the first past test results, inferential statistics for observing patterns in the first past test results, and a correlation analysis for discovering relationships between input parameters and testing outcomes for test cases included in the past test results.

In an embodiment, the processor further configured to: perform feature selection to determine parameters to focus on when executing the model, wherein the model comprises at least one of a decision tree, a random forest and a neural network outputting a prioritization of test cases.

In an embodiment, the processor further configured to: execute a prioritization algorithm to rank test cases from the set of test cases based on insights derived from the model.

In an embodiment, the processor further configured to: retrieve a previous model employing AI or ML developed for a third software application having one or more third functionalities corresponding to the one or more first functionalities of the first software application, wherein training the model comprises re-training the previous model in view of differences between the third software application and the first software application.

In an embodiment, the processor further configured to: execute the set of test cases to generate new test results for the first iteration of the first software application.

In an embodiment, the processor further configured to: re-train the model in view of the new test results.

In an embodiment, the processor further configured to: receive new information triggering a re-training of the model, the new information comprising user feedback regarding the first iteration of the first software application; and re-train the model in view of the user feedback.

In an embodiment, the processor further configured to: identify input parameters for a second iteration of the first software application having one or more updated first functionalities to be tested; and perform regression tests to determine whether the one or more updated first functionalities affected the one or more first functionalities.

In an embodiment, the processor further configured to: apply a defect prediction model to identify vulnerable aspects of the first iteration of the first software application.

In an embodiment, the processor further configured to: validate the model using cross-validation to assess the accuracy and reliability of the model.

### BRIEF DESCRIPTION OF THE DRAWINGS

FIG. 1 shows a flowchart for training a machine learning (ML) model according to various exemplary embodiments.

FIG. 2a shows a flowchart for training a decision tree according to one example of these exemplary embodiments.

FIG. 2b shows a flowchart for training a random forest according to one example of these exemplary embodiments.

FIG. 2c shows a flowchart for training a neural network according to one example of these exemplary embodiments.

FIG. 3 shows a flowchart for generating an optimized set of test cases according to various exemplary embodiments.

FIG. 4 shows a flowchart for optimized test case generation according to various exemplary embodiments.

FIG. 5 shows a system for software development including an automation testing platform according to various exemplary embodiments.

FIG. 6 shows a flowchart for a software development lifecycle according to various exemplary embodiments.

### DETAILED DESCRIPTION

The exemplary embodiments may be further understood with reference to the following description and the related appended drawings, wherein like elements are provided with the same reference numerals. The exemplary embodiments relate to systems and methods for optimizing the generation of test cases in software development processes. In particular, the exemplary embodiments are directed to models employing artificial intelligence (AI) and/or machine learning (ML) to generate sets of test cases that target critical functionalities of a software application to be tested, e.g., by prioritizing parameters or parameter combinations with a highest likelihood of revealing defects, while minimizing redundancy, e.g., by deprioritizing parameters or parameter combinations with a lower likelihood of revealing defects.

Those skilled in the art understand that software development is typically an iterative process including multiple stages of testing. To provide an illustrative example, a first iteration of a software application can undergo a first test or series of tests to reveal defects in the first iteration. After a software developer (or team of developers) attempts to address the defects in the first iteration, a second iteration of the software application may then undergo a second test or series of tests to reveal defects in the second iteration, e.g., by regression testing to ensure that new code changes (relative to the first iteration) have not adversely affected existing functionalities. This process may continue until a future iteration of the software application passes a series of tests to the satisfaction of the developer(s) such that the software application can be released.

Software testing generally involves the steps of defining software requirements and functionalities to test; creating a test plan; developing test cases; executing the test cases; and reporting defects identified during the execution of the test cases. The execution of these steps can include a combination of manual and automated processes. For example, defining software requirements/functionalities and creating a test plan can be manual processes while defect reporting may be automated. Test case generation and execution can be manual, automated, or a combination of manual and automated processes. For example, over the software development cycle, some test cases can be generated/executed manually, while other test cases can be automated, depending on, e.g., current testing goals. Particularly for complicated software, it may not be feasible to manually test every aspect of the code. Thus, it is common practice in software development to implement at least some automated testing processes for test case generation and execution.

A test case refers to a set of conditions under which a software application is run to determine whether the software functions correctly. In exhaustive testing, also referred to as brute force testing, every possible combination of input variables for a software application is covered by a respective test case. An exhaustive test may not be feasible for many software applications due to the time and processing demands required to test all combinations of input variables. Pairwise testing is a systematic approach to software testing that focuses on the generation and execution of test cases to cover, at least once, all possible pairs of input parameters.

This approach is based on the observation that most software defects are caused by interactions between pairs of input parameters rather than complex combinations. Pairwise test case generation can be automated, with a pairwise testing algorithm automatically filling a matrix or table with input parameters in a way that ensures that the test cases include every possible combination of two of the parameters. Existing pairwise testing processes can reduce the number of test cases relative to exhaustive testing. However, this may still impose a high processing/time burden and can potentially miss some software defects not adequately covered by the pairwise test.

Existing automation testing processes (including, e.g., automation testing services and/or frameworks) include a number of limitations, and the usefulness of these processes is similarly limited. Some existing automation testing services integrate pairwise testing. However, these services often require a significant amount of manual input and external tools to generate the pairwise combinations to be used as test cases.

Traditional test case generation often relies on manual processes or simple automation tools that may not comprehensively cover all possible input combinations, user scenarios, or system states. This can result in significant gaps in testing, where certain paths or interactions are not tested at all. Thus, critical defects may remain undetected until after release, potentially leading to user dissatisfaction, security vulnerabilities, or system failures.

Many current test case generation methods depend heavily on the expertise and intuition of the testing team to identify relevant test scenarios. This reliance on manual processes is not only time-consuming but is also prone to human error and bias. The quality and comprehensiveness of the test suite may vary significantly based on the experience of the testers, potentially overlooking complex or less obvious scenarios that could lead to defects. Edge cases, which represent extreme, unusual, or unexpected input combinations or conditions, are particularly challenging to identify and incorporate into test cases using conventional methods. Failure to test edge cases can result in software that behaves unpredictably or fails under certain conditions, undermining its reliability and robustness.

As software evolves, maintaining and updating the test suite to reflect changes in the codebase, requirements, or user scenarios can be cumbersome and inefficient with existing test case generation practices. Manual updates are labor-intensive and can lag behind the pace of development. The test suite may become outdated, leading to decreased relevance and effectiveness of testing efforts, and increased risk of regression issues. Current practices often provide limited feedback on the effectiveness of individual test cases or the overall test suite. There is a notable lack of mechanisms to analyze which tests are most valuable or how they can be optimized. This results in missed opportunities to refine the test suite for better coverage or efficiency, potentially wasting resources on redundant or low-value tests.

According to various exemplary embodiments described herein, systems and methods are described for optimized test case generation. The exemplary embodiments relate to an AI/ML framework for learning from historical data to predict aspects of code most likely to include defects and to focus testing efforts on these aspects.

The exemplary embodiments describe multiple different types of AI/ML functionalities with, for example, each functionality being directed to a specific task to be described in detail below. Those skilled in the art understand that artificial intelligence (AI) generally refers to computer-based systems and methods (e.g., algorithms) for simulating human intelligence. The term “AI” encompasses a wide range of techniques including, e.g., statistical methods and machine learning (ML) methods. Those skilled in the art understand that ML is a subset of AI and generally refers to computer-based systems and methods (e.g., algorithms) that learn from data to identify patterns and make decisions or predictions without explicit programming.

Some types of ML models undergo a training phase where training data including sets of input parameters and associated output parameters is fit to the model so that correlations can be made between the inputs/outputs. In supervised learning models, the training data is labeled such that each set of inputs/outputs includes one or more input features and a corresponding one or more output labels representing, e.g., correct answers or target values.

The supervised learning model learns from generalizing patterns from the labeled training data and iteratively adjusts its internal parameters to minimize differences between its predictions and output labels in the training set. These models are generally designed for regression tasks (e.g., to predict values from the input data) or for classification tasks (e.g., to assign a category to the input data). Some types of supervised learning models include linear regression, logistic regression, decision trees, and random forests. Each of these types of supervised learning models may be deployed for various tasks in test case generation according to the exemplary embodiments, to be explained in greater detail below.

Deep learning refers to a subset of ML in which a neural network composed of multiple layers and interconnecting nodes learns complex patterns and relationships through forward and backward propagation. Each node applies a weighted sum of inputs, applies an activation function and produces an output. Similar to supervised learning models, deep learning models can be trained using training data comprising sets of input/output values. The training process of a neural network is an iterative process in which the inputs of the training data are passed through the network (forward propagation), the calculated outputs are compared to the actual outputs by calculating a loss function, and the error is fed back through the model (backward propagation) so that the parameters of the neural network can be adjusted. Some types of deep learning models include feed-forward neural networks (FNN), convolutional neural networks (CNN) and recurrent neural networks (RNN). Each of these types of deep learning models may be deployed for various tasks in test case generation according to the exemplary embodiments, as explained in greater detail below.

Many different types of AI/ML modeling techniques can be employed for test case generation according to the present embodiments. Thus, the training and inference phases may vary based on the specific algorithms used. However, the training phase generally comprises fitting a model to training data and the inference phase generally comprises using the model to make decisions or predictions. Some AI/ML techniques can be deployed in a pre-processing phase to make historical data more suitable for processing by a further AI/ML technique, and some AI/ML techniques may be deployed in a post-processing phase to interpret the output of the inference.

In some aspects of these exemplary embodiments, the training and inference of a ML model comprise only one part of the overall optimization process. For example, the ML model may not directly output a set of optimized test cases. Rather, the set of optimized test cases can be assembled by, e.g., employing post-processing techniques on a set of inference data. In another example, the ML model may be employed in a pre-processing step. Various embodiments are described in detail below. In general, multiple different types of AI/ML modeling techniques may be employed for multiple different types of testing purposes, where some AI/ML techniques are more suitable for some testing purposes and other AI/ML techniques are more suitable for other testing purposes. These considerations are explored in detail below.

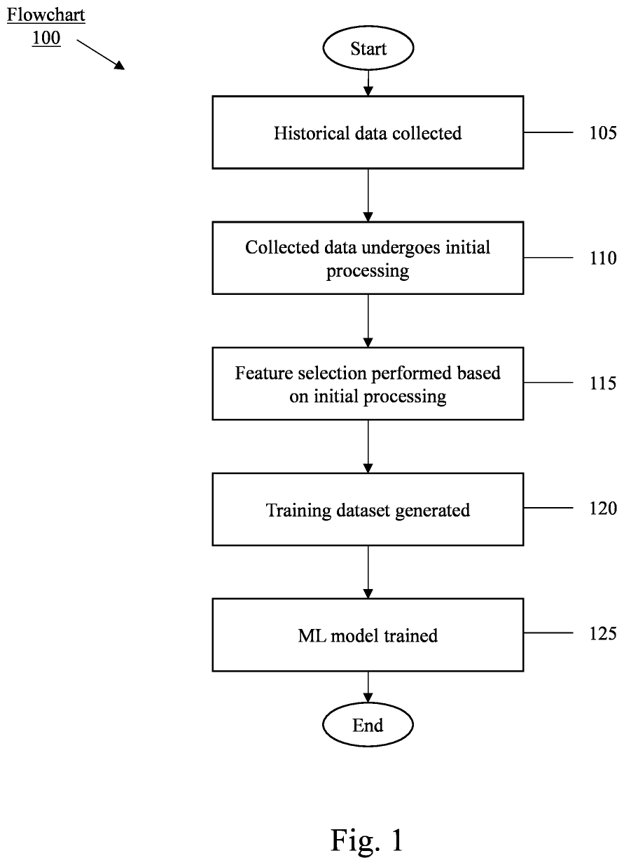

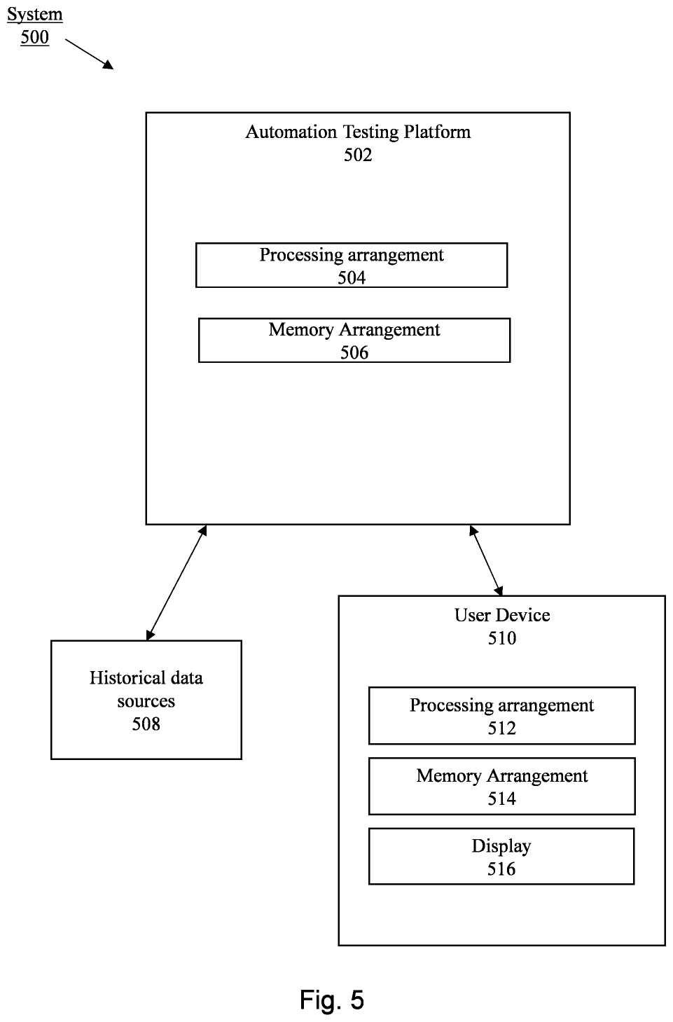

FIG. 1 shows a flowchart 100 for training a machine learning (ML) model according to various exemplary embodiments. The flowchart 100 is described with regard to a software application in development and is performed at an automation testing platform, e.g., the platform 502 described below with regard to FIG. 5.

In 105, historical data is collected for a software application to be tested. The historical data can be composed, for example, of many different types of data in many different forms from a variety of sources. A fundamental criterion for the collection of the historical data is relevancy to the current testing objectives of the software application in development. A further criterion for the collection of the historical data is the ability of the AI system to extract meaningful insights from the data. The historical data can comprise historical test results, software development artifacts (such as requirements, design documents, and code repositories), and operational data.

One type of historical data that can be collected is past test data for the software application in development. As described above, software development is an iterative process including many stages of testing. Past test results for a previous iteration of the current software application can highlight parts of code associated with defects and parts of code that were free of defects. The past test results can include the input parameter/variable set for the past test cases, the results for each test case, defect logs and resolutions, performance metrics, user feedback or issue reports. In one example, test results can include information on the test case executed, the specific input parameters used, the expected outcome, the actual outcome, and whether the test passed or failed. Additional details could include execution logs, error messages, etc.

To provide an illustrative example, a current software application in development may be a video streaming application. The historical data collected for a current testing cycle could include a dataset from a previous iteration of the video streaming application. Historical test results may highlight a high incidence of buffering issues under certain network conditions. The test data could detail the specific conditions under which these issues occurred, the severity of the buffering problems, and any user feedback or defect reports related to these issues. Analyzing this data can help the system to prioritize testing for similar conditions in the current version of the application, focusing on optimizing test cases to cover these high-risk scenarios.

The past test data for the current software application can be used (e.g., after some initial processing steps to be explained below), to train a ML model. Additionally, the past test data for the current software application can provide a basis for targeting the collection of further historical data. The further historical data can encompass test data from past versions of the same software application, similar software products, or even industry-wide data related to similar functionalities or technologies. To provide an illustrative example, if the current software application is a video streaming application for web/mobile, historical test data can be collected for other types of video streaming applications, other types of web/mobile applications, and/or other types of applications that have some similar functionalities in the video streaming application.

The historical data can come from multiple sources, including internal test databases, defect tracking systems, user feedback platforms, and potentially public datasets if they provide relevant insights into common defects or testing patterns for similar applications. The data could be proprietary data, e.g., owned by a software development company, or could be publicly available data from open-source projects or industry consortia.

In some cases, the current software application to be tested may be a first iteration of the software such that no prior test data is yet available. In these cases, it may be beneficial to perform an initial test to focus the collection of the historical data and to focus the AI/ML processing techniques to be used.

In one aspect of these exemplary embodiments, an initial pairwise test is run on an initial iteration of a software application in development. Collecting historical test data after conducting initial pairwise tests allows the system to focus on the collection and analysis of historical data based on insights gained from these initial tests. The results of pairwise testing can highlight specific areas of the software that are prone to defects or require further investigation. This focus helps in tailoring the historical data collection to be more relevant and targeted, enhancing the efficiency of the AI-driven optimization process. Initial pairwise testing results provide a fresh set of data that, when combined with historical test data, enriches the learning material of the AI model(s). This combination allows the AI system to better understand the current state of the software, including any new functionalities or changes, and adjust its analyses and predictions accordingly.

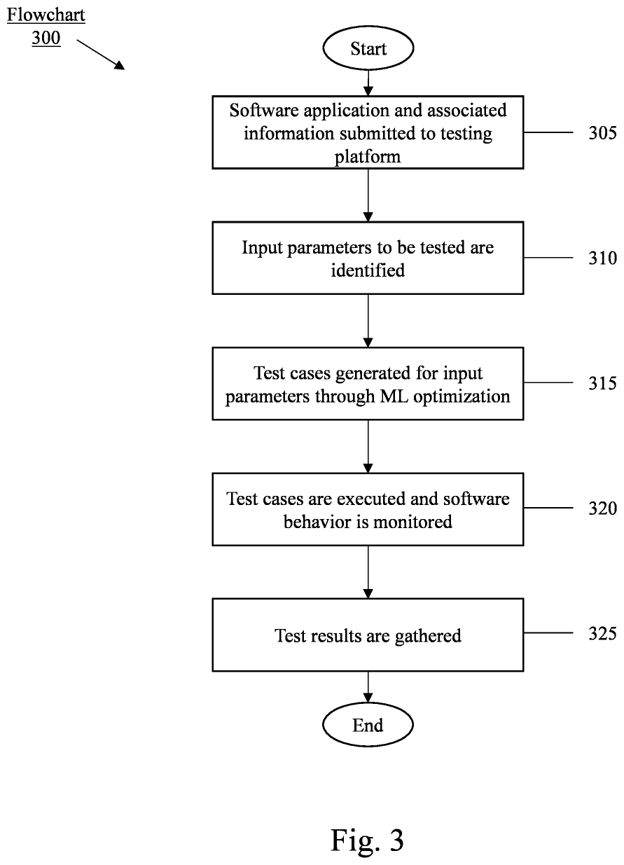

In another aspect of these exemplary embodiments, prior analyses performed by the AI system for different software applications can be applicable to the testing of a current software application. Insights derived from one product can inform testing strategies and optimizations for other products, especially those within the same domain or with similar features. This cross-product learning capability enhances the ability of the AI system to identify potential defects and optimize test cases across diverse software projects. In some embodiments, previously trained ML models, e.g., models developed for a different software application, can be retrieved and adapted for use for a current software application, to be described in greater detail below with regard to FIG. 3.

In another aspect of these exemplary embodiments, new historical data can be ingested by the system at any time, e.g., on a continuous basis as new data becomes available, on a periodic basis, upon user request, or at the beginning of a new testing cycle.

The collected historical data is cleaned, normalized, and structured to facilitate efficient analysis. This typically involves categorizing data by software components, test parameters, outcomes, defect types, and severity levels. Structuring the data in this way enables the system to perform targeted analyses, such as identifying frequently failing components or high-risk functionalities.

In 110, the collected historical data undergoes an initial phase of processing. This step generally includes applying one or more AI/ML techniques to performing initial analyses, e.g., pre-processing steps, so that correlations can be drawn between input parameters and testing outcomes. This step is used to inform feature selection for the training of a ML model and further provides training data for the ML model. In some embodiments, the results of these analyses can directly inform the generation of the optimized set of test cases, e.g., in a collaborative process across different AI/ML techniques, to be described in greater detail below.

In one aspect of these exemplary embodiments, descriptive statistics are applied to summarize and describe the features of the historical data. The descriptive statistics analysis is applied to understand the distribution, mean, variance, and other properties of the test data to identify trends, anomalies and patterns in the historical data. Descriptive statistics help in understanding the distribution of historical test data, guiding the system in identifying patterns or anomalies that could inform the prioritization or generation of new test cases.

The mean provides the average outcome of test cases, offering insights into general performance or defect rates (Mean (μ): μ=(1/N)*Σx_i). The variance and standard deviation measure the spread of test outcomes, indicating the consistency of software behavior under various test conditions (Variance (σ\hat{ }2): σ\hat{ }2=(1/(N−1))*Σ(x_i−μ)\hat{ }2; Standard Deviation (σ): σ=sqrt(σ\hat{ }2)).

In another aspect of these exemplary embodiments, inferential statistics are applied to make inferences about populations based on the sample data. In the context of test case optimization, these methods can determine if observed patterns in test data are statistically significant (e.g., relevant). The inferential statistics can infer the likelihood of software behaviors or defects from historical test data. The inferential statistics analysis can include analysis of variance (ANOVA) and hypothesis testing.

ANOVA is used to determine if there are statistically significant differences between the means of three or more independent groups (F=Between-group variability/Within-group variability). Hypothesis testing assesses if a certain condition (like a defect occurring) is statistically significant across different versions of the software. These analyses enable the system to discern meaningful patterns in test outcomes, such as identifying features or conditions that consistently lead to failures, thereby refining the test case selection process.

Thus, when considered in combination, the descriptive statistical analysis can summarize the historical test data, providing insights into general trends, variances, and patterns, while the inferential statistical analysis can make predictions about future test outcomes based on this historical data, identifying statistically significant patterns that could influence test case selection.

In another aspect of these exemplary embodiments, a correlation analysis is used to discover relationships between different test parameters and outcomes. The correlation analysis helps to identify which parameters are most influential in determining the success or failure of a test case. The correlation analysis can uncover dependencies between input parameters and their impact on the behavior of the software.

The correlation analysis measures the relationship between two variables. The Pearson Correlation Coefficient is a common measure used to assess the linear relationship between test parameters and outcomes (r=(n(Σxy)−(Σx)(Σy))/sqrt([nΣx\hat{ }2−(Σx)\hat{ }2][nΣy\hat{ }2−(Σy)\hat{ }2]). For interpreting this analysis, r values range from −1 to 1, where 1 means a perfect positive linear relationship, −1 means a perfect negative linear relationship, and 0 means no linear relationship. By identifying parameters that are strongly correlated with defects, the system can prioritize or generate test cases that focus on these high-risk areas, optimizing the testing effort for effectiveness in uncovering potential issues. In one illustrative example, for the video streaming application described above, the correlation analysis can identify a strong correlation between network latency and video load times in a streaming app, guiding the prioritization of these test cases.

In another aspect of these exemplary embodiments, a defect prediction model can assist the system in identifying areas of the software most vulnerable to defects. By focusing testing efforts on these high-risk areas, the optimization process becomes more efficient, ensuring that resources are allocated to testing scenarios that are most likely to uncover critical issues.

The defect prediction model can comprise, for example, Bayesian models or logistic regression. Bayesian Models use Bayes' Theorem to update the probability of a hypothesis as more evidence becomes available. In test case optimization, they can adjust the likelihood of defects based on new test results (P(H|E)=(P(E|H)*P(H))/P(E)). Logistic Regression models the probability of a binary outcome (defect or no defect) based on one or more independent variables (test parameters). It can be used to predict the likelihood of defects occurring in different testing scenarios (P(Y=1)=1/(1+e\hat{ }−(β_0+β_1X)). In one example, logistic regression analysis can predict the probability of defects in different modules of the application based on complexity metrics, change history, and past defect rates.

The defect prediction model can also be a more complicated AI/ML algorithm such as a random forest. The specific AI/ML technique used for the defect prediction analysis can depend on the nature of the data and the specificity of prediction required.

It is noted that the defect prediction analysis can comprise a pre-processing step (prior to training the ML model) or a post-processing step to help refine the set of the test cases generated in preceding steps.

The results of the foregoing analyses identify high-risk areas and parameter dependencies. These results inform feature selection for training a ML model.

In 115, feature selection is performed to determine the most relevant parameters to focus on in the testing process. Different features can be selected depending on the ML algorithm to be trained.

In 120, a training dataset is generated for a ML model in view of the above analyses. The format of the training data can depend on the type of machine learning algorithm to be trained. The collected/analyzed data is refined in view of the feature selection to make the data suitable for training the ML model.

The training data set can be structured to associate outcomes with specific conditions under which tests were executed. The training data set can be reduced and/or restructured relative to the historical test data in view of the results of the techniques described in 110 and the feature selection described in 115.

In various embodiments, the ML model can include decision trees, random forests and/or deep learning networks. Decision trees make decisions based on the values of input parameters, branching out to reach conclusions (test outcomes). They are simple yet powerful tools for classification and regression tasks. Decision trees can map out the logical paths leading to success or failure scenarios based on parameter values, making them ideal for generating test cases that mimic real-world usage.

A single decision tree is trained on a dataset by recursively partitioning the data into smaller subsets based on feature attributes to maximize the homogeneity of the target variable within each subset. In an inference phase, a prediction is made by traversing the tree from a root node to a leaf node based on the feature values of the input with the leaf node providing the predicted outcome. Decision trees are less complex than random forests or deep learning networks and are more easily interpretable. However, they can be prone to overfitting.

Random Forests improve on decision trees by creating an ensemble of trees based on random subsets of the dataset and averaging their predictions. This reduces the risk of overfitting and improves accuracy. The random forest can enhance prediction accuracy and robustness, helping to identify the most critical parameters to test. For example, a random forest can determine which user actions are most predictive of crashes in a mobile app, focusing testing on those paths.

For random forests, each single decision tree is trained independently based on a random subset of the training dataset and a random subset of features at each split. The aim is to reduce the correlation among the trees. In an inference phase, predictions from all of the decision trees are aggregated. Random forests are more complex than decision trees but mitigate the overfitting issue and have a high generalization capacity.

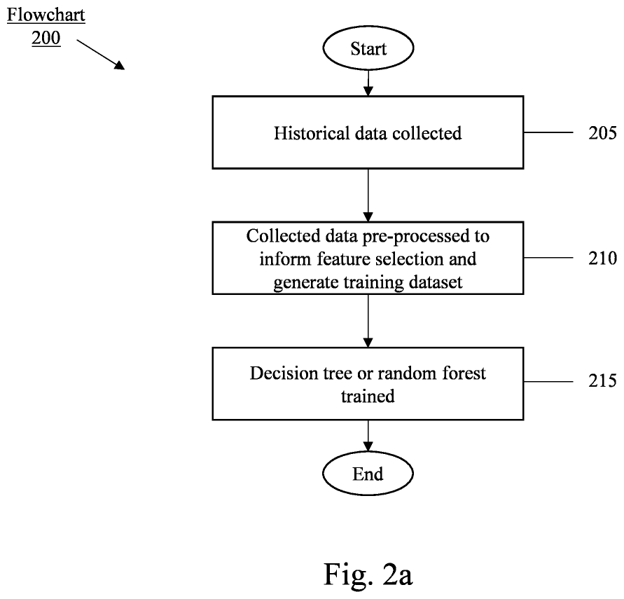

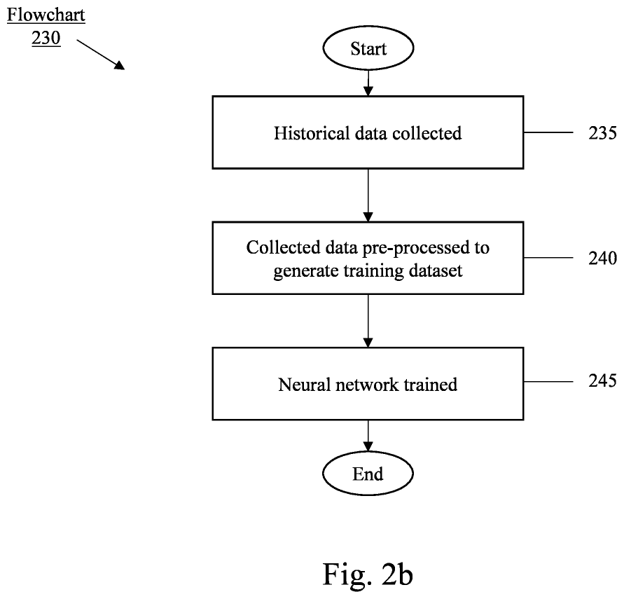

Both decision trees and random forests can use Gini importance or mean decrease in impurity (MDI) to calculate how each feature contributes to the homogeneity of the nodes and leaves in the decision trees. Decision tree and random forests can further refine the understanding of how different parameters interact and their impact on software behavior, prioritizing test cases that cover critical functionalities and potential defect hotspots, to be described in further detail below with regard to FIG. 2a. Decision trees and random forests can directly output a set of test cases or can directly influence the selection and prioritization of test cases.

Deep Learning Networks (composed of multiple layers of neurons) excel in identifying complex, non-linear relationships in large datasets. They are particularly useful for analyzing historical test data, learning intricate patterns that can predict test outcomes and/or identifying defect-prone areas. These algorithms enable the AI to learn from historical test data, predicting the likelihood of defects under various conditions. This predictive capability allows for the dynamic generation and prioritization of test cases, focusing efforts on scenarios most likely to reveal defects as will be described in further detail below with regard to FIG. 2b. Deep learning networks can directly output a set of test cases or can directly influence the selection and prioritization of test cases. In some cases, deep learning networks can be deployed to analyze relationships between code changes and test outcomes.

In 125, the ML model (e.g., the decision tree, random forest or deep learning model) is trained with the training dataset. Through iterative learning processes, the model adjusts its internal weights and parameters to minimize prediction errors, resulting in a trained model capable of making informed predictions about test outcomes.

The trained model is then ready for inferencing. In an inference phase, input parameters specific to the software application under the test can be input into the trained ML model. The format of the input parameters can vary based on the type of ML model and its purpose. These parameters can include functional requirements, user scenarios, performance benchmarks, and any known issues or areas of concern. The ML model uses the input parameters as a basis for generating test cases that are both relevant and optimized for coverage and efficiency.

In some embodiments, the inference of the trained model can directly output an optimized set of test cases. The trained model can apply its learned knowledge to the specific parameters of the software product, predicting the most effective test cases. This involves determining not only which combinations of input parameters are most likely to uncover defects but also prioritizing test cases based on their potential impact and relevance. The model outputs a set of optimized test parameters and corresponding test cases. Optimization here refers to maximizing coverage of critical functionalities and potential defect areas while minimizing the total number of test cases needed, thereby enhancing testing efficiency.

In other embodiments, the inference of the trained model can provide output in another form that is post-processed to generate an optimized set of test cases.

FIG. 2a shows a flowchart 200 for training a decision tree according to one example of these exemplary embodiments.

In 205, historical data is gathered. This step may, for example, be similar to step 105 of FIG. 1 described above.

In 210, the historical data is pre-processed to generate a training dataset for the decision tree. In some embodiments, a decision tree can be trained to process historical data that has already been run through various AI/ML processes to better structure the data for analysis and potentially highlight correlations that can improve the training of the decision tree. In other embodiments, a decision tree can be trained and deployed for outlining logical sequences of actions that lead to failures. The training dataset can include features specific to the type of application to be tested. In one example, for a streaming application, the training dataset can comprise features extracted from historical test cases, including test outcomes (pass/fail), execution time, coverage metrics, and associated code changes or bug reports. Each feature represents an aspect of the test case or the environment in which it was executed.

In 215, the decision tree is trained with the training dataset. The decision tree is then ready for inferencing. The input data for a trained decision tree or random forest model includes current project metrics, recent code changes, and potentially flaky test indicators. This data mirrors the structure of the training data but reflects the current state of the software project.

The output from these models can be a set of test cases, or may be a prioritization or classification of test scenarios based on the likelihood that a given test scenario will detect faults, its relevance to recent changes, or its historical effectiveness. For example, a decision tree might classify test scenarios into categories of high, medium, or low priority for execution.

In one example, the software application under test comprises a video streaming service. In this example, the training data for decision trees and random forests could include features such as: stream start times (peak vs. off-peak); user device types (mobile, desktop, smart TV); network conditions (Wi-Fi, 4G, 5G); user actions (play, pause, stop, seek); historical issues (buffering, errors, quality degradation); content types (live stream, on-demand video, music). The output can categorize test scenarios based on the likelihood that a given test scenario will uncover issues such as buffering delays, quality drops, or failures in content delivery, e.g., high priority, medium priority or low priority.

The high priority cases may be, e.g., test cases simulating 4G network conditions on mobile devices during peak hours, as historical data shows increased buffering issues in this scenario. The medium priority cases may be, e.g., test cases for smart TV devices using Wi-Fi, with occasional quality drops noted in the past. The low priority cases may be, e.g., desktop scenarios with stable network conditions, historically showing minimal issues. From these outputs, a set of test cases can be generated or prioritized, such as, e.g., simulating a live stream on mobile devices under various network conditions to detect buffering and quality issues or testing on-demand video playback on smart TVs during different times to assess quality consistency.

FIG. 2b shows a flowchart 230 for training a neural network according to one example of these exemplary embodiments.

In 235, historical data is gathered. This step can be similar to step 105 of FIG. 1 described above.

In 240, the historical data is pre-processed to generate a training dataset for the neural network. Similarly to the decision tree or random forest, in some embodiments, a neural network may be trained for processing historical data that has already been run through various AI/ML processes to better structure the data for analysis and potentially highlight some correlations that can improve the training of the random forest. In other embodiments, a neural network can be trained and deployed for feature selection to identify parameters that will most significantly affect software behavior.

In other embodiments, a neural network can be trained and deployed to process unstructured data, such as logs or user interactions, to identify testing scenarios. The neural network can predict user behavior or analyze textual requirements. For example, a convolutional neural network (CNN) for image analysis could analyze screenshots from UI tests to identify visual regressions or errors. In another example, a recurrent neural network (RNN) for sequential data can analyze sequences of actions in user sessions to predict failure points. In still other embodiments, a neural network can be trained to process code to identify potential failure points or user scenarios that require testing. Deep learning could be used in understanding natural language requirements or predicting user paths through an application based on historical usage data.

A neural network can be trained on complex data including textual descriptions of test cases, code diffs (changes/updates in code), and even semantic analysis of code changes. The training data can be structured to help the model understand the relationships between code changes and the impact on test outcomes.

In 245, the neural network is trained with the training dataset. The neural network is then ready for inferencing.

In some cases, rather than directly outputting a set of test cases, the neural network can provide insights such as a probability score indicating the likelihood of issues following a specific code update, or recommendations for areas of the platform that require more intensive testing based on user feedback analysis.

The use of the various ML models described above may depend on the complexity of the data and the specific testing challenges posed by the software product.

It is noted that the various AI/ML models described above may be used in test case generation through a process that involves analyzing the outputs of all the AI/ML models. In one example, insights can be aggregated by combining the outputs of, e.g., statistical methods and ML techniques to generate a comprehensive view of testing priorities and areas of concern. A prioritization algorithm can then be applied that considers the insights from the AI/ML models to rank test cases based on their predicted effectiveness, relevance to recent changes, and historical performance. The top-ranked test cases can be selected for execution.

FIG. 3 shows a flowchart 300 for generating an optimized set of test cases according to various exemplary embodiments.

In 305, a software application (e.g., the codebase) and associated information is submitted to the testing platform. In one example, the software application is a video streaming application. However, the system can be devised for the development of many different types of software, to be described in greater detail below.

The associated information can include a variety of information that can be used to focus the testing efforts. As those skilled in the art will understand, this information may include requirements, configurations, and additional inputs, etc. A set of requirements can include functional requirements, performance requirements, security requirements and/or usability requirements. Functional requirements include detailed descriptions of the application's functionality, expected behavior, and use cases. These requirements are crucial for defining what the application should do and serve as a basis for generating functional test cases.

Performance requirements include specifications related to performance benchmarks (e.g., load times, response times, and throughput rates, etc.). These help in crafting performance tests that ensure the application meets its performance criteria. Security requirements include information on security protocols, authentication mechanisms and data protection standards to which the application must adhere. This guides the creation of security-focused test cases aiming to uncover vulnerabilities. Usability requirements include insights into the user interface and user experience expectations. Although more subjective, these requirements can inform automated UI tests that check for compliance with design standards and accessibility guidelines.

Additionally, information such as environmental variables, test data, thresholds and limits, and feature flags or toggles can be provided. Environment variables refer to details about the test environments, such as operating systems, browser versions, and device configurations. These variables allow the testing service to tailor test executions to prioritize specific environments. Test data refers to sets of input data for the tests, which can often be configured to vary across test runs. This includes both valid inputs to test normal operation and invalid inputs to test error handling and edge cases. Thresholds and limits for performance testing refer to variables such as maximum acceptable response time or the target load (number of users) for stress tests can be configured to match the performance requirements. Feature Flags or Toggles refer to configuration options that enable or disable certain features of the application, allowing tests to focus on specific areas or functionalities depending on the current focus of the development cycle.

Additional information can be provided including integration points, known issues, and documentation/comments. Integration points refer to information about external services or APIs the application interacts with, which information is essential for testing integrations and to ensure that the application behaves correctly in the context of its dependencies. Known issues (or areas of concern) refer to developers highlighting particularly complex parts of the application, parts that have been problematic in the past, or parts that have undergone significant changes. This information helps prioritize testing efforts towards these high-risk areas. Comprehensive documentation and well-commented code can offer insights into the intended functionality and logic of the application, aiding in the creation of more accurate and relevant test cases. All of these forms of additional information can be provided to inform and/or focus the subsequent steps.

In 310, input parameters to be tested are identified. The system can analyze the codebase to identify configurable parameters or user inputs. Additionally, the associated information, e.g., software requirements, design documents, etc., can be analyzed to identify input parameters. These can include user inputs, configuration settings, environmental conditions, etc. These requirements can be provided to the testing platform manually by a developer or automatically through analyzing the documentation and codebase of the application.

The number and type of input parameters can depend on the objectives defined for the current testing cycle. In one example, the testing strategy may seek to uncover defects with performance or UI/UX and the input parameters are identified in dependence on these objectives.

In 315, the input parameters are passed through a ML optimization to generate an optimized set of test cases. In this example, the model analyzes these parameters in the context of historical data and predictive analytics to identify patterns, dependencies, and potential risk areas. These test cases are designed to maximize coverage of critical functionalities and potential defect areas while minimizing redundancy. The optimization process considers factors such as risk prioritization (e.g., by focusing on areas with a higher likelihood of defects), efficiency (e.g., by reducing the number of test cases needed to achieve comprehensive coverage), and relevance (e.g., by ensuring test cases are aligned with the most current version of the application and its usage scenarios).

In some cases, no trained AI/ML model is yet available and an initial trained model needs to be generated, e.g., according to the flowchart 100 of FIG. 1 described above.

In some cases, a previously trained AI/ML model is available for generating test cases for the software application. For example, the current iteration of software may not be a first iteration, and an AI/ML optimization may have previously been run. In some cases, the previously trained AI/ML model may be suitable for directly inferencing an optimized set of test cases in view of the input parameters identified in 210. For example, even if the testing parameters have changed slightly relative to the previous iteration, the AI/ML model may have a generalization capacity sufficient to ingest this new input data to output an optimized set of test cases. In other cases, the previously trained AI/ML model may have already generated an optimized set of test cases. If the input parameters have not changed since the last execution, then the optimization process does not need to be run again.

In other cases, where the previously trained AI/ML model is not suitable for direct inferencing, the model is retrained. The retraining may be performed, for example, based on the difference in input parameters relative to a previous iteration of the software. In still other cases, new historical data may be available, relative to the last time the previously trained AI/ML was trained, and the retraining of the AI/ML model may include the new information.

In still other cases, there may be no previously trained AI/ML model available for the current software application, however, the system may have information and/or trained models available that were developed for other software applications that have certain similarities to the current software application. In these cases, the system can retrieve one of these models and retrain it for use with the current software application. In a related embodiment, the system receives historical information collected for a different software application and uses this information to generate an AI/ML model specific to the current application.

In some cases, a prioritization algorithm is executed to interpret insights from multiple different AI/ML techniques and to identify input parameters for a first iteration of a first software application having one or more first functionalities to be tested.

In any case, a trained AI/ML model suitable for inferencing in view of the current software is made available and an optimized set of test cases is generated.

In 320, the test cases are executed and the behavior of the software is monitored. This step utilizes automated testing tools and simulators to run tests across various platforms, devices, and network conditions. Execution is monitored in real-time, with the ability to dynamically adjust testing strategies based on interim results.

In 325, the results of the tests are gathered. The results can be presented to a user for manual analysis. For example, a comprehensive report can include details on identified defects, coverage metrics, performance benchmarks, and user experience insights. Additionally, actionable recommendations can be provided to address any issues and suggestions for further optimizations. The results can also be stored for later use or immediately put to use in refining the AI/ML model.

The system according to these exemplary embodiments may include a feedback loop for continuous refinement. In this manner, the results of a test can be fed back into the AI system, further refining the test case generation process. This feedback loop allows the AI to learn from each testing iteration, continuously improving the efficiency and effectiveness of the test suite. Over time, this iterative process leads to a highly optimized set of test cases deeply aligned with the most critical testing needs of the software. This significantly reduces testing effort while maintaining or enhancing defect detection. The continuous refinement loop can enable the system to dynamically adapt test cases in response to changes in the codebase, requirements, or operating environment of the application, ensuring that the test suite remains relevant and effective over time without requiring manual updates.

As described above, an initial pairwise test can be run on a current iteration of a software application prior to execution of the AI/ML test case generation. The current iteration of the software application may be a first iteration, such that no prior test data is yet available for the software application. In this scenario, the initial pairwise test provides foundational information about the software application that informs the AI/ML optimization process.

The pairwise test can be run with orthogonal arrays. Orthogonal arrays (OAs) refer to a statistical method used to design experiments and, in the context of software testing, to generate test cases. They ensure that every possible pair of parameters is tested at least once. This is crucial for identifying interactions between pairs that may lead to defects.

The selection of an OA is based on the formula L\hat{ }k_n(t), where L is the number of levels (possible values) for each factor (parameter), n is the number of runs (test cases), k is the number of factors, and t is the strength (pairs for pairwise testing). OAs are matrices designed such that each column represents a parameter, and each row represents a test case. The arrangement is such that every combination of values for any pair of columns (parameters) appears an equal number of times across the rows (test cases).

The system according to the exemplary embodiments incorporates the pairwise algorithms directly into the system to allow for the automatic generation of pairwise test cases. Relative to existing services that require manual intervention or external tools for test case generation, the present system for automatic pairwise testing significantly reduces manual effort and improves efficiency.

The determination of when to run a pairwise test (without AI/ML optimization) can be made automatically. For example, the first time the system receives a first iteration of a new software application, a pairwise test can be automatically run. In some aspects, a pairwise test can be automatically run each time a new iteration of the software is received for testing. In other embodiments, the pairwise test can be run when the system detects that a certain degree of changes has been made in a new iteration of the software relative to a previous iteration. In still other embodiments, a developer can manually select to run a pairwise test at any time and for any reason. In any scenario, the new pairwise test can initiate a new round of AI/ML optimization.

In many cases, the optimized set of test cases is reduced relative to, e.g., the pairwise test. However, there is no requirement that the number of test cases be reduced. In some scenarios, the AI/ML model may identify multiple potential pathways that may lead to defects, which necessitates the generation of more test cases than are generated in the initial pairwise test. However, in many cases, test cases will be reduced relative to existing test case generation methods and coverage will be simultaneously enhanced.

In one illustrative example, a testing tool according to prior methods might identify 40 total parameters for testing and generate 100 test cases covering various functionalities and user scenarios, causing the testing platform to allocate resources for the 100 test cases (e.g., requiring approximately 3 hours to complete all test executions). In this example, the 100 test cases reveal playback errors, delayed response in content search, and occasional failures in user authentication.

In contrast, the system according to the present embodiments can identify additional parameters for testing (e.g., identifying 70 total parameters). From these 70 parameters, 150 optimized test cases are generated prioritizing critical and/or potential high-risk areas. Thus, the number of test cases has been increased by identifying the need to test for multiple additional potential defects. In this example, in addition to identifying the defects found in the conventional testing process, the system also uncovers issues with adaptive bitrate transitions and interface responsiveness during background activities. The system provides a comprehensive report with prioritized defects, predictive insights on potential future issues, and recommendations for optimizations.

In the following, some illustrative examples are provided to demonstrate the approach to test case generation according to the present embodiments. In these examples, the software application under test is a video streaming application.

In one example, a testing objective is to ensure the streaming application dynamically adjusts video quality based on network speed to provide uninterrupted viewing experiences. In this case, input parameters are identified and defined to include video bitrate options (e.g., 144p, 360p, 720p, 1080p), network speeds (e.g., 2G, 3G, 4G, WiFi), and content types (e.g., live stream, on-demand video). An initial pairwise test is run to cover all pairwise combinations of bitrate options and network speeds to ensure comprehensive testing of adaptive streaming functionality. The varying network conditions are simulated using network simulation tools and the test cases are executed to observe how the application adjusts video quality. The test results are analyzed for issues such as excessive buffering or failure to downgrade quality under low bandwidth. Optimizations to the test suite can be suggested based on patterns identified in the data.

In another example, a testing objective is to verify that the streaming application delivers consistent user experiences across different devices and operating systems. In this case, input parameters are identified and defined to include devices (e.g., smartphones, tablets, smart TVs), operating systems (e.g., ios, Android, WebOS), and app versions. An initial pairwise test is run to cover all pairwise combinations of devices, operating systems, and app versions, focusing on critical functionalities like playback, navigation, and user authentication. The test cases are executed to observe UI responsiveness, load times, and interaction flows. The test results are analyzed to identify inconsistencies or failures across platforms. Optimizations to the test suite can be suggested for potential device-specific or OS-specific issues.

In still another example, a testing objective is to analyze the response of an application to user interactions (e.g., play, pause, seek) under various conditions, including incoming calls or notifications. In this case, input parameters are identified and defined to include user interaction scenarios and environmental conditions, such as receiving a phone call during video playback or getting a notification during live streaming. An initial test is run to simulate these scenarios, ensuring each interaction is tested under different conditions. The test results are analyzed to identify how the application manages playback and user state during and after interruptions and to identify issues in resuming content or maintaining user context.

In some embodiments, an AI/ML model may be transferred from one module of the system, e.g., a first module for development of a first application, to another module of the system, e.g., a second module for development of a second application. In cases of model transfer, the generalization capacity of AI/ML models is a critical factor. Models with high generalization ability can apply learned insights across different contexts, making them valuable for testing a wide range of software products. To enhance generalization, models can be trained on diverse datasets that cover various software types, domains, and testing scenarios. Techniques such as transfer learning and domain adaptation can further refine the model's ability to adjust to new software parameters without extensive retraining. The success of a model transfer can depend on the similarity between the source and target domains, as well as the model's ability to adapt to new parameters.

Models with proven generalization capacities can be transferred to other domains. In some cases, these models can be used directly in the other domain, e.g., if the model was trained on software information similar to the software of the other domain. In other cases, transfer learning techniques can be applied to adapt existing models to new software contexts. In one embodiment, input parameters of the new software can be mapped to the existing model so that the model can interpret the new software.

In one illustrative example, an existing software application may have been previously developed for video streaming using the AI/ML framework described herein. In this case, a previous model was trained to generate test cases for testing a video encoding process, which, for the existing software application, is according to the H.264 standard. The previous model was trained on input parameters including bitrate variations, network conditions, user device types, and viewer behaviors, successfully identifying test cases that pinpoint buffering issues, quality degradation, and latency problems.

In this example, the owners of the existing software application have decided to upgrade their video encoding process to the more efficient H.265 (HEVC) standard to improve video quality at lower bitrates, aiming to enhance user experience, especially for those with limited bandwidth. This transition introduces new testing challenges as the platform needs to ensure that the benefits of H.265 are realized without introducing unforeseen issues.

Accordingly, it is decided to leverage the existing model trained on the H.264 encoding process for use with the H.265 encoding process. Through transfer learning techniques, the model is quickly adapted to understand the nuances of H.265 encoding, including its impact on streaming quality, buffering, and data consumption across various devices and network conditions. The model's high generalization capacity allows it to apply insights from the H.264 data to the H.265 context effectively. For instance, it predicts that certain mobile devices might experience increased buffering during peak hours due to the higher computational demands of decoding H.265 content. Utilizing these insights, the model generates a set of optimized test cases specifically designed to assess the performance of the H.265 encoding under various real-world scenarios, such as streaming over 3G/4G networks, on different smartphone models, and during network congestion periods.

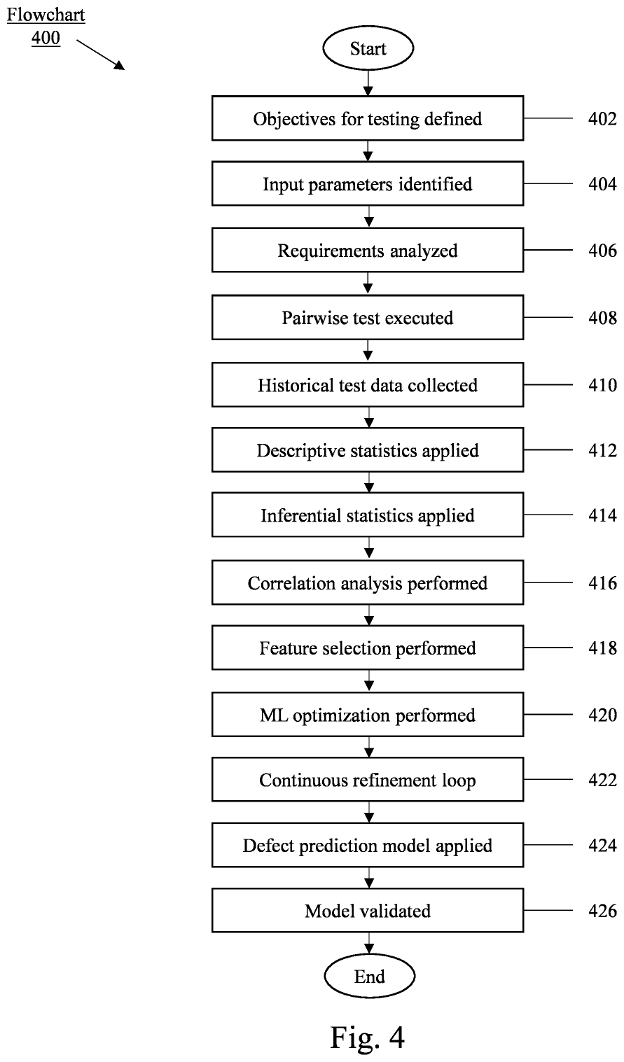

FIG. 4 shows a flowchart 400 for optimized test case generation according to various exemplary embodiments. The flowchart 400 describes one specific AI/ML implementation for test case generation.

In 402, objectives for the testing including goals, scope and constraints are defined. This provides a clear direction for the optimization efforts.

In 404, input parameters are identified. All software parameters requiring testing are listed, including user inputs, configuration settings, and environmental conditions.

In 406, functional and non-functional requirements are analyzed to ensure comprehensive test coverage.

In 408, a pairwise test is run. Utilizing Orthogonal Arrays and Combinatorial Design theory, pairwise combinations of input parameters are generated to ensure every possible pair of parameters is tested at least once. A minimized set of test cases covering all pairwise interactions is produced.

In 410, historical test data is collected based on the initial pairwise test and in view of the objectives, input parameters, and the functional/non-functional requirements. This data provides empirical insights for statistical analysis and model training.

In 412, descriptive statistics are applied to identify trends, anomalies and patterns in the historical data. The descriptive statistics analysis is applied to understand the distribution, mean, variance, and other properties of the test data.

In 414, inferential statistics are applied to determine the relevance of observed patterns in the data. The inferential statistics analysis can include hypothesis testing and ANOVA.

In 416, a correlation analysis identifies dependencies between test parameters and outcomes.

In 418, the above analyses of 412-416 inform feature selection for an ML optimization.

In 420, the ML optimization is performed. In this step, one or more ML models is/are trained in view of the data produced through the above analyses. The ML model(s) can include regression, classification algorithms, and optimization algorithms (such as, e.g., genetic algorithms). The one or more ML models infers an optimized set of test cases.

In 422, the process continuously adapts, collecting new data and performing real-time analysis to refine the test suite and models. Necessary updates can trigger a loop back to feature selection in 418 and model optimization in 420-422.

In 424, a defect prediction model is applied. Bayesian or logistic regression models predict potential defects, guiding focused testing efforts.

In 426, the model is validated. Techniques like k-fold cross-validation validate the accuracy and reliability of machine learning models. The statistical significance of model improvements is assessed to guide implementation.

The process concludes with the deployment of the optimized test suite, marking the end of the current optimization cycle. However, the iterative nature of the process ensures continuous improvement as new data is collected.

FIG. 5 shows a system 500 for software development including an automation testing platform 502 according to various exemplary embodiments. The platform 502 can be hosted on a server or a cloud computing platform. The platform 502 includes an interface for retrieving historical data from historical data sources 508. The platform 502 further includes an interface for interacting with a remote user device 510.

The platform 502 of this example includes a processing arrangement 504 and a memory arrangement 506. Those skilled in the art understand that the processing arrangement 504 can comprise any number of individual processors distributed throughout the architecture of the platform 502 and the memory arrangement 506 can comprise any number of individual memories distributed throughout the architecture of the platform 502. Those skilled in the art understand that the platform 502 can include a number of other components including but not limited to ports to electrically connect the platform 502 to, e.g., other electronic devices and/or power sources, communications components including, e.g., transceivers or ports for wired connections, etc.

The processing arrangement 504 may be a hardware component configured to execute operations for software development according to the various exemplary embodiments described above. The memory arrangement 506 may be a hardware component configured to store data related to operations performed by the platform 502.

The memory arrangement 506 can include data in many forms. For example, the memory arrangement 506 could include a first portion for storing unaltered historical data retrieved from the historical data sources 508; a second portion for storing structured historical data, e.g., historical data that has undergone some degree of processing to make the data more suitable for further analysis; a third portion storing the results of various AI/ML processes previously performed on the structured historical data; and a fourth portion storing trained AI/ML models.

The memory arrangement 506 can include portions specific to a given software application in current development. It should be understood that the platform 502 can support the development of multiple distinct software applications simultaneously. In one example, a module of the platform 502 directed to the development of a first software application can receive information from a module of the platform 502 directed to the development of a second software application.

The platform 502 can be accessed by a user device 510 via one or more communications networks. The platform 502 and the user device 510 can communicate in any manner (e.g., wirelessly or using a wired connection). Those skilled in the art will understand the procedures and protocols that may be implemented for each of the content provider the platform 502 and the user device 510 to connect to a network and communicate with a remote endpoint via the network connection. For example, the platform 502 may comprise a cloud computing platform including network protocols for communications between the platform 502 and the user device 510.

The user device 510 comprises hardware components including a processing arrangement 512, a memory arrangement 514, a display 516 and other components. The other components can include, e.g., an input/output (I/O) device, ports to electrically connect the user device 510 to, e.g., other electronic devices and/or power sources, communications components including, e.g., transceivers or ports for wired connections, etc.

The user device 510 can access the platform 502 to facilitate the development of a software application. An application can be run on the user device 510 that provides a graphical user interface (GUI) configured to be displayed on the display 516 so that a user can interface with the platform 502, visualize test processes, results, etc. For example, the user device 510 can provide manual inputs for software testing tasks, execute commands for, e.g., test execution, etc. After a test has been run, the platform 502 can provide test results to the user device 510 for display by the display 516. The GUI is tailored to enhance the testing experience including, for example, intuitive controls for defining test parameters, initiating test runs, and customizing views of results. Advanced features like predictive text, automated suggestions for test optimization, and drag-and-drop functionality for test case management may also be included.

The platform 502 is in communication with the historical data source 508 and the user device 510 via secure network connections that support the transfer of test cases, test results, AI model updates, etc. Security measures are implemented to safeguard the testing process, protect proprietary data and ensure the integrity of test results. This includes implementing encryption for data in transit and at rest, using secure authentication mechanisms, and applying access controls to sensitive resources.

The architecture of the system 500 is designed to accommodate growth. For example, implementing the platform 502 at a cloud computing platform will allow the system 500 to handle an increasing load of test cases, expanding datasets for AI training, and a larger number of concurrent user devices without degradation in performance. The system 500 is further designed for capability with development tools Ci/CD pipelines, and version control systems.

The platform 502 generates comprehensive reports and dashboards, e.g., for display at the user device 510, that offer insights into the testing process, outcomes, and AI optimizations. Customizable alerts and logs provide real-time feedback and facilitate data-driven decision-making.

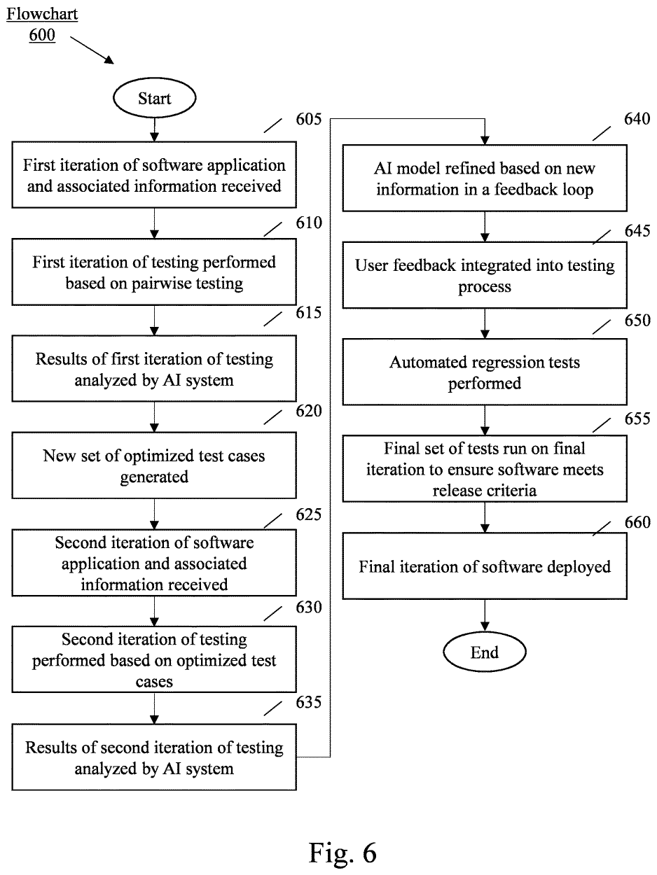

FIG. 6 shows a flowchart 600 for a software development lifecycle according to various exemplary embodiments.

In 605, a first iteration of a software application and associated information (requirements, etc.) is received by the automation testing platform. The first iteration is included with, e.g., detailed specifications, user stories, earlier test cases, etc., to provide a baseline for initial testing strategies and AI model calibration.

In 610, a first iteration of testing is performed.

Initially, a comprehensive set of test cases is generated based on pairwise testing without AI optimization. This first iteration aims to establish a baseline of the software behavior and identify any immediate defects. For a video streaming application, the first iteration of testing could include test cases covering various network conditions, user interactions, and streaming qualities to ensure broad coverage.

In 615, the results from the first iteration of testing are analyzed by the AI system, which also considers historical data, trends, and patterns identified in similar applications or past versions of the same application.

In 620, the AI system generates a new set of test cases for the next iteration of testing. The system identifies key parameters and scenarios that led to defects or exhibited risky behavior, as well as those that consistently passed without issues. The new set of test cases can be smaller than that of the pairwise test by deprioritizing or eliminating test cases that add less value to the testing process, e.g., reducing test cases deemed unlikely to reveal defects. The new set of test cases can also be greater than that of the pairwise test if multiple critical functionalities are identified. If desired, the new set of test cases can be run on the first iteration of the software. Alternatively, the new set of test cases can be stored until a second iteration of the software is ready for testing. There is no requirement that the optimized set of test cases be executed successively with the initial pairwise test. For example, the initial pairwise test may reveal defects that a developer may decide to address with code changes prior to any additional testing. However, the optimized test cases will be available for the next round of testing.

In 625, a second iteration of the software application and associated information (requirements, etc.) is received by the automation testing platform. The second iteration may have minor changes relative to the first iteration, major changes relative to the first iteration, different requirements/objectives relative to the first iteration, etc.

In 630, a second iteration of testing is performed. If the second iteration of the software comprises only minor changes relative to the first iteration, then the second iteration of testing can be run using the set of test cases from 620. For example, if the first iteration revealed that certain network conditions or user actions were particularly prone to causing streaming interruptions, the second iteration would prioritize these scenarios, potentially reducing the number of test cases related to stable features like user authentication.

If the second iteration of the software comprises major changes or a change in testing objectives, then the AI/ML model can be retrained in view of this new information to output an updated set of test cases. In some scenarios, a new AI/ML model can be generated to output an updated set of test cases.

In 635, the results from the second iteration of testing are analyzed by the AI system and another new set of test cases can be generated, further refining the test case generation process. This feedback loop allows the AI to learn from each testing iteration, continuously improving the efficiency and effectiveness of the test suite. Over time, this iterative process leads to a highly optimized set of test cases deeply aligned with the software's most critical testing needs, significantly reducing unnecessary testing effort while maintaining or enhancing defect detection.

In one example, referring to 610, a first iteration of testing includes 100 test cases covering a wide range of functionalities and scenarios. Referring to 615, after the first iteration, analysis reveals that 20% of the parameters are linked to 80% of the identified defects, particularly under specific network conditions and during certain user interactions. Referring to 620, leveraging this insight, the system optimizes the test suite, generating 60 test cases for the next iteration. These cases focus intensively on the identified high-risk areas, such as adaptive bitrate changes under fluctuating network conditions and user interactions during data-intensive operations, while deprioritizing areas that showed consistent stability.

In 640, in a feedback loop, the AI model is refined and updated based on new information to ensure that the model remains accurate and effective in predicting areas of concern and optimizing test cases.

The feedback loop could further include the collection of new historical data. This can include test results, defect logs, etc. from recent tests of other software products. The new historical data can also encompass updates to the software product, including new features, bug fixes, changes in user interfaces, or modifications in underlying technologies. It also includes fresh test results, defect findings, and user feedback specific to the current product iteration. Gathering updated information about the current product allows the system to recalibrate its testing focus, ensuring that the test cases are aligned with the latest version of the software. This is crucial for maintaining the relevance and effectiveness of the testing process, especially in agile development environments where rapid iterations are common.

The newly collected data is analyzed in conjunction with the existing dataset. The AI models in the system use this comprehensive dataset to identify new testing priorities, potential defect hotspots, and areas where test coverage can be improved or needs to be updated due to changes in the software.

Based on the analysis, the AI models may undergo re-training to incorporate the latest insights and data. This step is critical for ensuring that the models remain accurate and effective in predicting defects, optimizing test cases, and identifying the most relevant testing parameters.

With updated models, the system generates a revised set of optimized test cases. This set reflects the latest understanding of the software's behavior, user interactions, and potential failure points. The optimization process focuses on enhancing test efficiency by eliminating redundant tests, prioritizing high-risk areas and adapting to new features or changes in the software.

The results of executing the optimized test cases are fed back into the system, further enriching the dataset and informing subsequent iterations of the refinement loop. This feedback mechanism ensures a continuous cycle of improvement, making the testing process increasingly refined and focused over time.

In 645, user feedback and market analysis data are integrated into the testing process. This allows the AI system to consider user satisfaction and competitive benchmarks in test case optimization. This holistic approach ensures that testing aligns not only with technical requirements but also with user expectations and market standards.

In 650, automated regression tests are performed to ensure that new changes have not adversely affected existing functionality. Performance benchmarking is conducted to measure the impact of changes on the software's performance, with the AT system analyzing trends and anomalies.

In 655, a final set of tests on a final iteration of software, focused on deployment readiness, is executed to ensure that the software meets all release criteria. This includes security assessments, load testing, and compatibility checks across different environments and platforms.

In 660, the final iteration of software is deployed. After deployment, the system can engage in post-deployment monitoring to capture real-time user interactions and system performance. The feedback loop of 640 can be run continuously in view of updated information.

The system described above may be suitable for the development of many different types of software. In some embodiments, the system may be particularly suitable for the development of web, mobile, and over-the-top (OTT) applications. Web and mobile applications exhibit several defining characteristics that distinguish them from other software types, such as desktop applications, embedded systems, or enterprise software solutions. Web applications must operate across various browsers and versions, while mobile applications need to function on a wide range of devices with different screen sizes, operating systems (ios, Android), and hardware capabilities. This platform diversity/fragmentation requires testing strategies that can adapt to multiple environments without compromising on quality or performance.

These applications are directly interacted with by end-users and are thus designed with a strong emphasis on user interface (UI) and user experience (UX). Testing needs to ensure that UI elements are responsive, intuitive, and accessible across devices and platforms. Web and mobile applications often rely on network connectivity to fetch data, update content, or synchronize user activities. Testing must account for varying network speeds, latency, and offline scenarios to ensure consistent functionality. The development cycles for web and mobile applications are characterized by rapid iterations, with frequent updates and feature releases. This necessitates a testing solution that can quickly adapt to changes, ensuring that new or updated functionalities are thoroughly tested before deployment.

OTT applications refer to services that deliver content (video, audio, text, or multimedia) directly over the internet to consumers, bypassing traditional distribution channels such as broadcast, cable, or satellite television providers. The term “over-the-top” signifies that these services go “over” the same network infrastructure that delivers internet access, without the involvement of the network provider in the control or distribution of the content. OTT applications can be considered a specialized subset of web and mobile applications, characterized by their content delivery model.

While they share underlying technologies and platforms with general web and mobile apps (e.g., HTML5, iOS, Android), OTT apps have distinct operational and performance requirements driven by their focus on content streaming. OTT services are accessible through web applications (e.g., via browsers on desktops or mobile devices) and dedicated mobile applications (e.g., native apps designed for smartphones or tablets). This dual presence underscores the hybrid nature of OTT applications as both web and mobile entities.

OTT applications, especially those streaming high-definition video or live events, demand significant network bandwidth and low latency to deliver a smooth user experience. This necessitates specialized testing to ensure performance under varying network conditions. OTT applications often employ adaptive bitrate streaming technologies (e.g., MPEG-DASH, HLS) to dynamically adjust video quality based on the user's internet speed. Testing these applications requires validating the seamless transition between different bitrates and the app's ability to minimize buffering or playback interruptions. Protecting copyrighted content is crucial for OTT services, which implement Digital Rights Management (DRM) solutions to control access and distribution. Testing OTT apps involves verifying the integration and functionality of DRM systems across different devices and platforms. Given the variety of devices and platforms OTT apps operate on (smart TVs, gaming consoles, smartphones, tablets, web browsers), ensuring a consistent and intuitive user interface across all access points is a key testing focus.

The types of software application can include video streaming apps, music streaming apps, games, message board platforms, shopping platforms, educational apps and platforms, and health or fitness apps. In other embodiments, the software can be a highly specialized application, an application with ultra-low latency requirements, or deeply embedded systems. These might require interaction with specialized hardware. However, the test case generation capabilities described above may be applied for these specialized applications.

Test cases can be optimized according to the defining features of the software and current testing goals. For example, test cases can be developed that focus on validating UI/UX aspects, e.g., taps and swipes. An AI/ML optimization cycle can focus on historical data related to UI/UX testing. For example, analysis of historical data can reveal a correlation between user swipe patterns and code errors. In another example, test cases can be developed that focus on performance, e.g., device performance under varying network conditions. In still another example, test cases can be developed that focus on different device specifications, e.g., everything from smart TVs and set-top boxes to smartphones and tablets.

The system according to the present embodiments analyzes the structure, functionality, and user interaction patterns of a software application, automatically generating a wide range of test cases that cover not only common scenarios but also edge cases and complex interaction sequences. This approach ensures a more comprehensive coverage than manual methods. AI models are trained to identify and generate test cases for edge conditions based on historical data, code analysis, and predictive modeling. This ensures that even the most unlikely scenarios are considered and tested. Testing edge cases enhances the robustness and reliability of the software, ensuring it behaves as expected under a wide range of conditions.

By achieving broader test coverage, the system significantly reduces the risk of missing critical defects, ensuring that the software is thoroughly vetted for a variety of conditions and use cases. From identifying test parameters to generating and executing test cases, the system automates the entire testing process. This minimizes the reliance on manual efforts and subjective decision-making in test case creation. Automation speeds up the testing process, allowing for more frequent and extensive testing cycles. It also enhances the consistency and repeatability of tests, leading to more reliable outcomes.

The system dynamically updates the test suite in response to changes in the application, such as new features or bug fixes. It automatically revises, adds, or removes test cases to reflect the current state of the software, maintaining the relevance and effectiveness of the test suite over time. Continuous maintenance of the test suite ensures that testing efforts remain aligned with the development process, supporting agile and iterative development methodologies.

Leveraging cloud-based infrastructure and parallel processing, the system can scale testing efforts to accommodate projects of any size or complexity without compromising speed or thoroughness. This scalability ensures that testing is not a bottleneck in the development process, facilitating timely releases and efficient resource utilization.

The system analyzes test results using advanced data analytics to provide insights into the effectiveness of each test case and the overall test suite. It identifies areas for optimization, such as removing redundant tests or focusing on high-risk areas. These insights enable continuous improvement of the testing process, ensuring that testing efforts are focused and efficient, maximizing the value of each test executed.

The system provides a unified testing solution that seamlessly integrates web, mobile, and OTT application testing within a single framework. This unified approach simplifies test management, reduces the learning curve for testers, and ensures consistency in testing methodologies across different platforms.

The AI components of the system enable it to learn from every test execution, adapting and refining test cases and strategies based on outcomes, trends, and anomalies detected over time. This refinement learning loop ensures that testing evolves in parallel with the application, maintaining effectiveness and efficiency as the software and its environment change.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a Linux based OS, a mobile device having an operating system such as iOS, Android, etc. In a further example, the exemplary embodiments of the above-described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A computer-implemented method for training a machine learning (ML) model for generating test cases for software testing, comprising:
collecting historical data from one or more digital repositories, the historical data comprising past test results for a first software application having one or more first functionalities and at least one second software application having one or more second functionalities corresponding to the one or more first functionalities of the first software application, the past test results at least including input parameters and testing outcomes for each test case included in the past test results;
creating a first training dataset structured to associate the testing outcomes with the input parameters under which test cases were executed; and
training the ML model with the first training dataset to generate a trained ML model.

2. The method of claim 1, wherein the ML model is a decision tree or a random forest.

3. The method of claim 2, further comprising:
executing the trained ML model with input data comprising first input parameters for the first software application; and
generating output data comprising a classification of testing scenarios for prioritizing test cases for the first software application.

4. The method of claim 3, wherein the classification of testing scenarios is based on a likelihood of a given testing scenario to reveal defects.

5. The method of claim 3, further comprising:
when a next iteration of the first software application is received for testing, creating a second training dataset comprising code changes relative to a previous iteration of the first software application or bug reports for the previous iteration of the first software application; and
re-training the trained ML model with the second training dataset to generate a re-trained ML model.

6. The method of claim 5, wherein the classification of testing scenarios is based on a relevance to code changes between the next iteration and the previous iteration of the first software application.

7. The method of claim 1, wherein the ML model is a neural network.

8. The method of claim 7, wherein the first training dataset further comprises code changes for a next iteration of the first software application relative to a previous iteration of the first software application included in the past test cases, the method further comprising:
generating output data comprising a classification of testing scenarios based on a relevance to code changes between the next iteration and the previous iteration of the first software application.

9. An automation testing system, comprising:
a memory configured to store historical data collected from one or more digital repositories, the historical data at least comprising past test results including input parameters and testing outcomes for each test case included in the past test results; and
a processor configured to:
identify input parameters for a first iteration of a first software application having one or more first functionalities to be tested;
execute an initial test on the first iteration of the first software application to generate initial test results;
based on the input parameters and the initial test results, collecting first historical data at least comprising first past test results for at least one second software application having one or more second functionalities corresponding to the one or more first functionalities of the first software application;
training a model employing artificial intelligence (AI) or machine learning (ML) based on the initial test results and the first historical data to generate a trained model; and
executing the trained model with the input parameters as input to generate a set of test cases for testing the one or more first functionalities of the first software application.

10. The system of claim 9, wherein the initial test is a pairwise test run with orthogonal arrays, wherein the pairwise test provides a basis for collecting the first historical data.

11. The system of claim 9, wherein the model is trained based on statistical analysis of the first historical data, the statistical analysis comprising at least one of descriptive statistics for summarizing and describing the first past test results, inferential statistics for observing patterns in the first past test results, and a correlation analysis for discovering relationships between input parameters and testing outcomes for test cases included in the past test results.

12. The system of claim 11, the processor further configured to:
perform feature selection to determine parameters to focus on when executing the model, wherein the model comprises at least one of a decision tree, a random forest and a neural network outputting a prioritization of test cases.

13. The system of claim 12, the processor further configured to:
execute a prioritization algorithm to rank test cases from the set of test cases based on insights derived from the model.

14. The system of claim 9, the processor further configured to:
retrieve a previous model employing AI or ML developed for a third software application having one or more third functionalities corresponding to the one or more first functionalities of the first software application, wherein training the model comprises re-training the previous model in view of differences between the third software application and the first software application.

15. The system of claim 9, the processor further configured to:
execute the set of test cases to generate new test results for the first iteration of the first software application.

16. The system of claim 15, the processor further configured to:
re-train the model in view of the new test results.

17. The system of claim 9, the processor further configured to:
receive new information triggering a re-training of the model, the new information comprising user feedback regarding the first iteration of the first software application; and
re-train the model in view of the user feedback.

18. The system of claim 9, the processor further configured to:
identify input parameters for a second iteration of the first software application having one or more updated first functionalities to be tested; and
perform regression tests to determine whether the one or more updated first functionalities affected the one or more first functionalities.

19. The system of claim 9, the processor further configured to:
apply a defect prediction model to identify vulnerable aspects of the first iteration of the first software application.

20. The system of claim 9, the processor further configured to:
validate the model using cross-validation to assess an accuracy and reliability of the model.
